(19) United States
(12) Patent Application Publication
(10) Pub. No.: US 2008/0144989 A1
(43) Pub. Date: Jun. 19, 2008

(54) OPTICAL SWITCH AND OPTICAL TEST APPARATUS

(75) Inventor: TAKAO SAKURAI, TOKYO (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ADVANTEST CORPORATION, TOKYO (JP)

(21) Appl. No.: 11/766,116

(22) Filed: Jun. 21, 2007

Related U.S. Application Data
(63) Continuation of application No. PCT/JP05/22101, filed on Dec. 1, 2005.

(30) Foreign Application Priority Data
Dec. 22, 2004 (JP) 2004-372108
Dec. 1, 2005 (JP) PCT/JP2005/022101

(51) Int. Cl. G02F 1/035

(52) U.S. Cl. 385/3

(57) ABSTRACT

An optical switch is provided. The optical switch includes: a first distributed-coupling type optical coupler having a first optical waveguide and a second optical waveguide arranged in parallel with each other that outputs an input light inputted to an input end of the first optical waveguide from an output end of either the first optical waveguide or the second optical waveguide as output light; a first electrode that applies an electric field corresponding to the first input voltage to the first optical waveguide and the second optical waveguide and controls whether the input light inputted to the first optical coupler is outputted as the output light based on the first input voltage; and a phase modulation reducing section that reduces the phase change of the output light in accordance with the change of the electric field applied to the first optical waveguide and the second optical waveguide.

### CROSS-REFERENCE TO RELATED APPLICATION

This is a continuation application of PCT/JP2005/22101 filed on Dec. 1, 2005 which claims priority from a Japanese Patent Application NO. 2004-372108 filed on Dec. 22, 2004, the contents of which are incorporated herein by reference.

### BACKGROUND

1. Technical Field

The present invention relates to an optical switch and an optical test apparatus. Particularly, the present invention relates to an optical switch and an optical test apparatus by using a distributed-coupling type optical coupler.

2. Related Art

Generally, a distributed-coupling type optical coupler has been used as a type of optical coupler. The distributed-coupling type optical coupler includes an optical coupler having a first optical waveguide and a second optical waveguide in parallel with and adjacent to each other and an electrode that applies an electric field to the first optical waveguide and the second optical waveguide to generate electrooptic effect. The distributed-coupling type optical coupler can control which of the first optical waveguide and the second optical waveguide outputs an input light inputted to the first optical waveguide based on whether a voltage is applied to the electrode.

The distributed-coupling type optical switch can be controlled by turning on/off a voltage, and it does not require that a predetermined DC bias such as a Mach-Zehnder optical switch is constantly applied to the distributed-coupling type optical switch. Therefore, drift effect that a substrate is charged by applying the DC bias to change the operating point of the optical switch is less likely to occur, so that a stable operating characteristic can be obtained. Therefore, such distributed-coupling type optical switch is commonly used for optical switching which needs a high extinction ratio.

Patent document 1 as Japanese Patent Application Publication No. 60-76722 discloses a matrix optical switch being capable of switching M×N optical connections by using plurality of distributed-coupling type optical switches.

Patent document 2 as Japanese Patent Application Publication No. 5-53157 discloses an optical control device includes a first optical coupler having a first optical waveguide and a second optical waveguide, for switching any optical wave guide from which an input light is outputted, and a second optical coupler disposed between an output port of the first optical waveguide from which the output light is outputted and the first optical coupler. In the second patent document, the second optical coupler is used to increase the extinction ratio for switching the first optical coupler. Specifically, when the first optical coupler is controlled so as not to output the output light to the first optical waveguide, the second optical coupler switches such that crosstalk light is outputted to an optical waveguide not used for optical communication, but is not outputted from the output port.

According to the above described patent documents 1 and 2, the extinction ratio can be further increased by providing multistage optical couplers).

In addition, in a patent document 3 as Japanese Patent Application Publication No. 2004-354960, electrodes are arranged corresponding to two optical waveguides forming a cross-directional coupler provided in the directional coupled modulator and a direct current is applied thereto, so that a chirp parameter of the directional coupled modulator can be set (see FIG. 18 and so forth).

In the case that the distributed-coupling type optical switch (Δβ type) is used by employing a normally-off type i.e. selecting an input/output port being turned off without applying a voltage and dynamically driven and turned on/off at high speed, phase modulation remains because the electric field is applied to the optical waveguide and a frequency chirp of the output light is generated as described in a Non-patent document 1. When the distributed-coupling type optical switch is used for generating an optical pulse of an OTDR (Optical Time Domain Reflectometer), the normally-off type is employed so as to apply DC without generating DC drift in order to obtain a high extinction ratio. Therefore, chirp is generated in the optical pulse, so that the frequency of light incident on an optical fiber-under test could be changed due to the chirp of the output light. Therefore, the accuracy of measurement of the OTDR is reduced. The chirp parameter can be controlled in the patent document 3, however, the phase modulation dynamically generated due to dynamically driving the optical switch can not be appropriately reduced, Moreover, since a waveguide such as a Ti diffused waveguide onto a ferroelectric crystal is formed on the surface of a substrate, a crossed waveguide as described in the Patent document 3 can not be formed.

Non-patent document 1: “Frequency Chirping in External Modulators,” IEEE Journal of Lightwave Technology, Vol. LT-6, No. 1, January 1988.

### SUMMARY

Thus, the object of the present invention is to provide an optical switch and an optical test apparatus which are capable of solving the problem accompanying the conventional art. The above and other objects can be achieved by combining the features recited in independent claims, Then, dependent claims define further effective specific example of the present invention.

In order to solve the above described problems, a first aspect of the present invention provides an optical switch including: a first distributed-coupling type optical coupler having a first optical waveguide and a second optical waveguide arranged in parallel with each other that outputs an input light inputted to an input end of the first optical waveguide from an output end of either the first optical waveguide or the second optical waveguide as output light; a first electrode that applies an electric field corresponding to the first input voltage to the first optical waveguide and the second optical waveguide and controls whether the input light inputted to the first optical coupler is outputted as the output light based on the first input voltage; and a phase modulation reducing section that reduces the phase change of the output light in accordance with the change of the electric field applied to the first optical waveguide and the second optical waveguide.

The phase modulation reducing section may change the phase of the output light substantially by the same amount and in the reverse direction with respect to changing the phase of the output light in accordance with the change of the electric field applied to the first optical waveguide and the second optical waveguide.

The phase modulation reducing section may include: a distributed-coupling type second optical coupler having a third optical waveguide to which the output light outputted from the output end of the first optical waveguide is inputted and a fourth optical waveguide arranged in parallel with the third optical waveguide that outputs the output light of which phase modulation by the first optical coupler is reduced from the third optical waveguide; and a second electrode that applies to the third optical waveguide and the fourth optical waveguide an electric field in the direction opposite to that of the electric field applied from the first electrode to the first optical waveguide and the second optical waveguide in accordance with the first input voltage, and changes the phase of the output light propagating through the third optical waveguide substantially by the same amount and in the reverse direction with respect to changing the phase in the first optical coupler.

The phase modulation reducing section may include a third optical waveguide that receives the output light; and a second electrode that applies to the third optical waveguide the electric field in the direction opposite to that of the electric field applied from the first electrode to the first optical waveguide in accordance with the first input voltage, and changes the phase of the output light propagating through the third optical waveguide substantially by the same amount and the reverse direction with respect to changing the phase in the first optical coupler.

The optical switch may further include a timing adjusting section that adjusts such that a time period for which the first input voltage is applied to the second electrode after the first input voltage is applied to the first electrode is substantially equal to a time period for which the output light is inputted to the third optical coupler after the input light is inputted to the first optical coupler.

The phase modulation reducing section may include: a distributed-coupling type second optical coupler having a third optical waveguide to which light is inputted from the outside, the input light is inputted to the first optical waveguide and a fourth optical waveguide arranged in parallel with the third optical waveguide; and a second electrode that applies to the third optical waveguide and the fourth optical waveguide an electric field in the direction opposite to the electric field applied from the first electrode to the first optical waveguide and the second optical waveguide in accordance with the first input voltage, and changes the phase of the input light propagating the third optical waveguide substantially by the same amount and in the reverse direction with respect to changing the phase in the first optical coupler.

The phase modulation reducing section may include: a third optical waveguide to which light is inputted from the outside, the input light is inputted to the first optical waveguide; and a second electrode that applies to the third optical waveguide an electric field in the direction opposite to the electric field applied from the first electrode to the first optical waveguide in accordance with the first input voltage, and changes the phase of the input light propagating the third optical waveguide substantially by the same amount and in the reverse direction with respect to changing the phase in the first optical coupler.

The optical switch may further include a timing adjusting section that adjusts such that a time period for which the first input voltage is inputted to the first electrode after the first input voltage is the second electrode is substantially equal to a time period for which light is inputted to the first optical waveguide after the input light is inputted to the third optical coupler.

The phase modulation reducing section may include: a distributed-coupling second optical coupler having a third optical waveguide to which the output light outputted from the output end of the first optical waveguide is inputted and a fourth optical waveguide arranged in parallel with the third optical waveguide that outputs the output light of which phase change by the first optical coupler is reduced from the fourth optical waveguide; an input voltage converting section that generates the second input voltage by subtracting the first input voltage from a predetermined reference voltage; and a second electrode that applies to the third optical waveguide and the fourth optical waveguide an electric field in the direction the same as that of the electric field applied from the first electrode to the first optical waveguide and the second optical waveguide in accordance with the second input voltage, and changes the phase of the output light propagating the third optical waveguide and the fourth optical waveguide substantially by the same amount and in the reverse direction with respect to changing the phase in the first optical coupler.

The optical switch may further include a timing adjusting section that adjusts such that a time period for which the second input voltage is applied to the second electrode after the first input voltage is applied to the first electrode is substantially equal to a time period for which the output light is inputted to the third optical waveguide after the input light is inputted to the first optical waveguide.

The phase modulation reducing section may include: a distributed-coupling type second optical coupler having a third optical waveguide to which light is inputted from the outside and a fourth optical waveguide arranged in parallel with the third optical waveguide, wherein the input light inputted to the third optical waveguide is inputted to the first optical waveguide; an input voltage converting section that generates the second input voltage by subtracting the first input voltage from a predetermined reference value; and a second electrode that applies to the third optical waveguide and the fourth optical waveguide an electric field in the direction the same as that of the electric field applied from the first electrode to the first optical waveguide and the second optical waveguide in accordance with the second input voltage, and changes the phase of the input light propagating through the third optical waveguide substantially by the same amount and in the reverse direction with respect to changing the phase in the first optical coupler,

The optical switch may further include a timing adjusting section that adjusts such that a time period for which the first input voltage is applied to the first electrode after the second input voltage is applied to the second electrode is substantially equal to a time period for which light is inputted to the first optical coupler after the input light is inputted to the third optical waveguide.

A second aspect of the present invention provides an optical test apparatus including: a light emitting section that emits light; a pulse generator that generates a pulse signal; an optical switch that switches whether the light emitted from the light emitting section is outputted based on the pulse signal; a directional coupler that inputs the light outputted from the optical switch to an external optical waveguide and acquires a reflected light from the external optical waveguide; and a phase detecting section that detects the phase of the reflected light acquired from the external optical waveguide. The optical switch includes: a first distributed-coupling type optical coupler having a first distributed-coupling type optical coupler having a first optical waveguide and a second optical waveguide arranged in parallel with each other that outputs an input light inputted to an input end of the first optical waveguide from an output end of either the first optical waveguide and the second optical waveguide as output light; a first electrode that applies an electric field corresponding to the first input voltage to the first optical waveguide and the second optical waveguide and controls whether the input light inputted to the first optical coupler is outputted as the output light based on the first input voltage; and a phase modulation reducing section that reduces the phase change of the output light in accordance with the change of the electric field applied to the first optical waveguide and the second optical waveguide.

Here, all necessary features of the present invention are not listed in the summary of the invention. The sub-combinations of the features may become the invention.

### BRIEF DESCRIPTION OF THE DRAWINGS

FIG. 1 shows a configuration of an optical switch 10 according to an embodiment of the present invention;

FIG. 2A is a cross-sectional view showing the optical switch 10 according, to an embodiment of the present invention by AA′ line;

FIG. 2B is a cross-sectional view showing the optical switch 10 according to an embodiment of the present invention by BB line;

FIG. 3 shows a frequency chirp of the optical switch 10 according to an embodiment of the present invention;

FIG. 4 shows a configuration of the optical switch 10 according to a first modification of an embodiment of the present invention;

FIG. 5 shows a configuration of the optical switch 10 according to a second modification of an embodiment of the present invention;

FIG. 6 is a cross-sectional view of the optical switch by CC line according to the second modification of an embodiment of the present invention;

FIG. 7 shows a configuration of the optical switch 10 according to a third modification of an embodiment of the present invention;

FIG. 8 shows a configuration of the optical switch 10 according to a fourth modification of an embodiment of the present invention;

FIG. 9 shows a configuration of the optical switch 10 according to a fifth modification of an embodiment of the present invention;

FIG. 10 shows a configuration of an optical test apparatus 20 according to an embodiment of the present invention;

FIG. 11 shows actual measuring data of an optical pulse shape generated by the optical switch according to an embodiment of the present invention and the frequency chirp thereof,

### DESCRIPTION OF EXEMPLARY EMBODIMENTS

The invention will now be described based on preferred embodiments, which do not intend to limit the scope of the invention, but exemplify the invention. All of the features and the combinations thereof described in the embodiments are not necessarily essential to the invention.

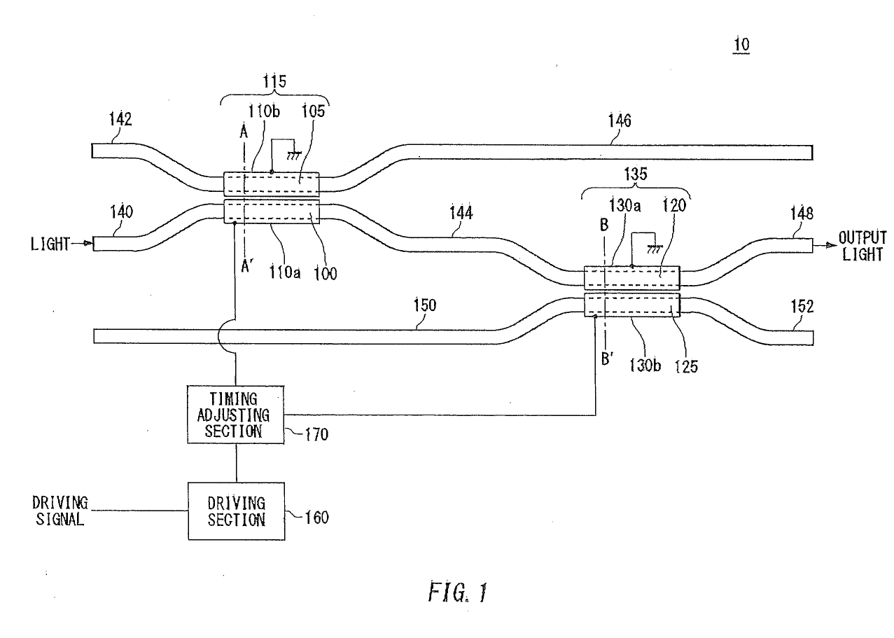

FIG. 1 shows a configuration of an optical switch according to an embodiment of the present invention. The optical switch 10 switches whether the input light is outputted from the optical coupler 10 by the optical coupler 115. The optical switch 10 according to the present embodiment reduce the phase modulation of the output light by the optical coupler 115 and outputs the same to prevent from generating a chirp.

The optical switch 10 includes an optical coupler 115, electrodes 100 (110a and 110b), an optical coupler 135, electrodes 130 (130a and 130b), a plurality of optical waveguides (140, 142, 144, 146, 148, 150 and 152), a driving section 160 and a timing adjusting section 170.

The optical coupler 115 is a distributed-coupling type optical coupler having a first optical waveguide 100 and a second optical waveguide 105 arranged in parallel with each other. The optical coupler 115 functions as an optical switch that outputs as an output light the input light inputted to an input end of the first optical waveguide 100 from an output end of either the first optical waveguide 100 or the second optical waveguide 105.

The electrodes 110 apply the electric field in accordance with the first input voltage inputted from the driving section 160 through the timing adjusting section 170 to the first optical waveguide 100 and the second optical waveguide 105. Thereby it is controlled whether the input light inputted to the optical coupler 115 is outputted from the output end of the optical waveguide 100 as the output light of the optical coupler 115 in accordance with the first input voltage. The electrodes 110 according to the present embodiment include an electrode 110a which is provided on the top surface of the optical waveguide 100 and to which a positive input voltage is applied, and an electrode 110b which is provided on the top surface of the optical waveguide 105 and grounded.

The optical coupler 135 is a distributed-coupling type optical coupler including a third optical waveguide 120 that receives the output light outputted from the output end of the first optical waveguide 100 and a fourth optical waveguide 125 arranged in parallel with the third optical waveguide 120. The optical coupler 135 outputs from the third optical waveguide 120 an output light of which phase change due to switching in the optical coupler 115 is reduced.

The electrodes 130 apply the electric field in the direction opposite to that of the electric field applied from the electrodes 110 to the first optical waveguide 110 and the second optical waveguide 105 to the third optical waveguide 120 and the fourth optical waveguide 125 in accordance with the first input voltage inputted from the driving section 160 through the timing adjusting section 170. Thereby the electrodes 130 change the phase of the output light propagating through the third optical waveguide 120 substantially by the same amount and in the reverse direction with respect to changing the phase in the optical coupler 115. The electrodes 130 according to the present embodiment include an electrode 130a which is provided on the top surface of the optical waveguide 120 and grounded and an electrode 130b which is provided on the top surface of the optical waveguide 125 and to which a positive input voltage is applied. In the present embodiment, each of the optical coupler 135 and the electrode 130 is an example of phase modulation reducing section according to the present invention.

The optical waveguide 140, the first optical waveguide 100, the optical waveguide 144, the third optical waveguide 120 and the optical waveguide 148 are formed as an integrated optical waveguide by dispersing metal such as titanium over a substrate made of ferroelectric crystal material such as LiNbO₃ and LiTaC₃. The optical waveguide 140 has an optical input port for the optical switch 10 at the input end and receives light from the outside, where the light inputted from the outside is inputted to the input end of the first optical waveguide 100 as an input light. The optical waveguide 144 guides to the third optical waveguide 120 the output light outputted from the output end of the first light waveguide 100 as the result of switching by the optical coupler 115 and the electrodes 110. The phase of the output light inputted to the third optical waveguide 120 is modulated by the optical coupler 135 and inputted to the optical waveguide 148. The output end of the optical waveguide 148 is used as an optical output port from which the output light of the optical switch 10 is outputted, and such as an optical fiber that outputs the output light of the optical switch 10 is connected thereto.

The optical waveguide 142, the second optical waveguide 105 and the optical waveguide 146 are integrally formed as well as the optical wave guides 140-148. The optical waveguide 146 propagates therethrough an output light when the input light inputted from the optical waveguide 140 to the optical coupler 115 is outputted from the output end of the second optical waveguide 105 as the output light. The output end of the optical waveguide 146 is not used as an optical output port that outputs the output light of the optical switch 10, and the optical fiber is not connected thereto, for example.

The optical waveguide 150, the fourth optical waveguide 125 and the optical waveguide 152 are integrally formed as well as the waveguides 140-148. The optical waveguides 150-152 are provided in order to provide an optical coupler 135 of which structure is substantially the same as that of the optical coupler 115. Thereby the phase modulation substantially opposite to the phase modulation generated in the optical coupler 115 at switching can be generated in the optical coupler 135.

The driving section 160 receives a driving signal that instructs to drive the optical switch 10 and generates an input voltage applied to the electrode 110 and the electrodes 130 in response to the driving signal. That is, the driving section 160 generates an input voltage of 0V when the driving signal indicates logical value L and applies the voltage to the electrodes 110a and 130b through the timing generating section 170, for example. Here, the optical waveguide 100 and the optical waveguide 105 are arranged in parallel with each other in length corresponding to the perfect coupling length provided that the input Voltage is 0V. Therefore, when the input voltage is 0V, the input light from the optical waveguide 140 is outputted from the optical waveguide 105 and emitted. Through the optical waveguide 146. Meanwhile, when the driving signal indicates logical value H, the driving section 160 generates a predetermined positive input voltage and applies the same to the electrode 110a and the electrode 130b through the timing adjusting section 170. In this case, the refractive index of each of the optical waveguide 100 and the optical waveguide 105 is changed, so that the length for which the optical waveguide 100 and the optical waveguide 105 are arranged in parallel with each other is not corresponding to the perfect coupling length. As the result of this, the input tight from the optical waveguide 140 is outputted from the optical waveguide 100, and outputted from the optical switch 10 through the optical waveguide 144, the optical waveguide 120 and the optical waveguide 148. Here, it is preferred that the input voltage applied to the electrode 110a and the electrode 130b when the driving signal indicates logic value H has a voltage value that maximizes the ratio of outputting the input light from the optical waveguide 100 and minimizes the ratio of outputting the input light from the optical waveguide 105.

The timing adjusting section 170 adjusts such that a time period for which the first input voltage is applied to the electrodes 130 after the first input voltage is applied to the electrodes 110 is substantially equal to a time period for which the output light is inputted to the third optical waveguide 120 in the optical coupler 135 after the input light is inputted to the optical coupler 115. That is, the timing adjusting section 170 adjusts such that the delay time for which the first input voltage is applied to the electrode 130b after the first input voltage is applied to the electrode 110a is approximately equal to the delay time for which the input light is inputted to the optical waveguide 120 through the optical waveguide 100 and the optical waveguide 144 after the input light is inputted to the optical waveguide 100 in the present embodiment. Thereby the timing adjusting section 170 ca phase-modulate the light of which phase is modulated by switching by the optical coupler 115 at the same timing and in the reverse direction and cancel the phase modulation by the optical coupler 115.

Here, it is preferred that the electrodes 110 and the electrodes 130 are traveling-wave electrodes which are connected to the timing adjusting section 170 near the optical input side. In this case, the input voltage applied to the electrodes 110 and the electrodes 130 propagates through the electrode 110 and the electrode 130 at the speed the same as the speed at which light propagates through the optical coupler 115 and the optical coupler 135. Thereby the electric field according to the timing of light propagating through the optical coupler 115 and the optical coupler 135 can be appropriately applied, so that a switching can be more speedily performed.

As described above, the optical switch 10 includes the phase modulation reducing section having the optical coupler 135 and the electrodes 130, so that it can reduce the change of the phase of the output light in accordance with the change of the electric field applied to the first optical waveguide 100 and the second optical waveguide 105. Specifically, the phase modulation reducing section can change the phase of the output light outputted from the output end of the optical waveguide 100 substantially by the same amount and in the reverse direction with respect to changing the electric field applied to the first waveguide 100 and the second waveguide 105 and cancel the phase modulation by the optical coupler 115.

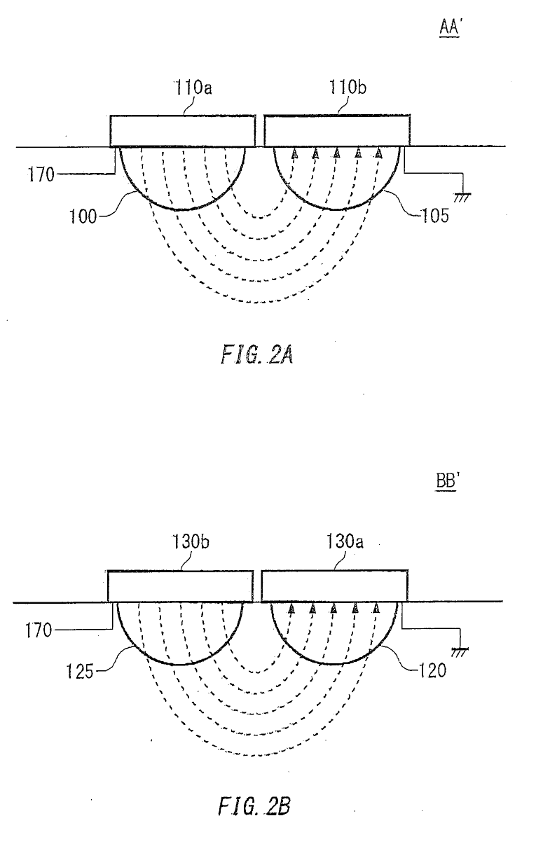

FIG. 2 is a cross sectional view of the optical switch according to the present embodiment. FIG. 2A is a cross section of the optical coupler 115 of the optical switch 10 by AA′ line. The optical switch 10 according to the present embodiment is provided on the substrate which is cut out such that the z-axis direction of LiNbO₃ crystal is vertical to the substrate. The optical waveguide 100 and the optical waveguide 105 are provided by dispersing metal such as titanium over the substrate. The electrode 110a is provided on the top surface of the optical waveguide 100 on the substrate and receives the input voltage from the timing adjusting section 170. The electrode 110b is provided on the top surface of the optical waveguide 105 on the substrate and grounded to 0V.

When a positive input voltage is applied to the electrode 110a, the electric field extending from the electrode 110a to the electrode 110b is generated. Thereby the electric field extending from the top surface direction to the under surface direction of the substrate is applied to the optical waveguide 100. Meanwhile, the electric field extending from the under surface direction to the top surface direction of the substrate is applied to the optical waveguide 105. As described above, the electric fields applied to the optical waveguide 100 and the optical waveguide 105 are in the direction approximately vertical to the substrate, i.e. in the z-axis direction of the LiNbO₃ crystal, so that the maximum optical effect is generated.

FIG. 2B shows a cross section of the optical switch 10 by BB′ line. An optical waveguide 1020 and an optical waveguide 125 are provided by dispersing metal such as titanium over the substrate made of LiNbO₃. The electrode 130a is provided on the top surface of the optical waveguide 120 and grounded to 0V. The electrode 130b is provided on the top surface of the optical waveguide 125 on the substrate and receives the input voltage from the timing adjusting section 170.

When a positive input voltage is applied to the electrode 130a, the electric field extending from the electrode 130a to the electrode 130b is generated. Thereby the electric field extending from the top surface direction to the under surface direction of the substrate is applied to the optical waveguide 125. Meanwhile, the electric field extending from the under surface direction to the top surface direction of the substrate is applied to the optical waveguide 120.

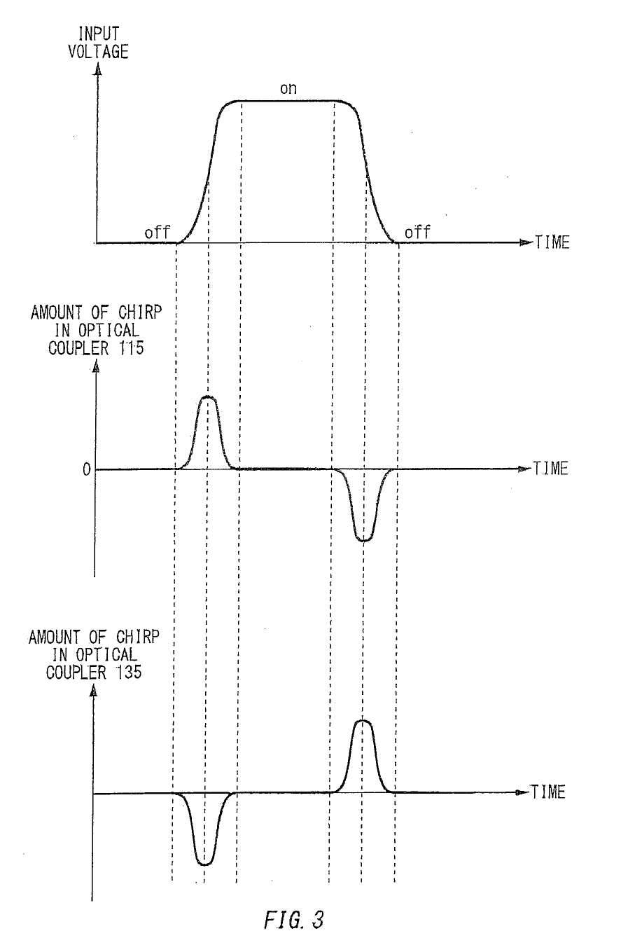

FIG. 3 shows a frequency chirp in an output waveguide 144 of the optical switch 10 according to the present embodiment. When the logical value of the driving signal is switched from L to H while a coherent laser beam is inputted to the optical waveguide 100 through the optical waveguide 140, the light intensity in the even mode guided through the optical waveguide 100 side is higher than that in the odd mode guided through the optical waveguide 105 side. At this time, the phase of the light in the odd mode and even mode is changed along with changing the electric field applied to the optical waveguide 100 and the optical waveguide 105, so that a light frequency chirp is generated. Positive or negative of the chirp is determined dependent on the direction of LiNbO₃ crystal, here, a positive chirp is illustrated in FIG. 3. In the same way, when the logical value of the driving signal is switched from H to L, a negative chirp is generated. The chirp between the input and the output of the optical waveguide 100 is indicated by the amount of change of the phase, i.e. the derivative as the following expression.

$$\frac{1}{2 π} \frac{d φ}{d t} = \frac{Δ {β}^{′}}{γ} \cdot \frac{( {κ}^{2} sin ( γ L ) \cdot cos ( γ L ) + γ L Δ {β}^{2}}{( {κ}^{2} cos ( γ L ) + Δ {β}^{2} )}$$

where, φ is the phase of light wave, L is the perfect coupling length, k is a mode coupling constant (κ=π/(2L), Δβ(=β₂−β₃)=2, where, β₂ is a propagation constant of light in the optical waveguide 100, β₃ is a propagation constant of light in the optical waveguide 105, Δβ is the differential value between the propagation constant of light in the optical waveguide 100 and the propagation constant of light in the optical waveguide 105, Δβ′ is the time derivative of Δβ and γ is (κ²+Δβ²)^{1/2}.

In an optical measurement by means of a fast optical transmission or a heterodyne detection, the transmission accuracy or the measurement accuracy could be reduced due to generating the chirp. Thus, in the optical switch 10 according to the present embodiment, the optical coupler 135 is disposed behind the optical coupler 115 in order to cancel the chirp generated by the optical coupler 115.

More specifically, the timing adjusting section 170 changes the input voltage of the electrode 130b from 0V to the voltage value the same as that of the electrode 110a at the same phase at which the input voltage of the electrode 110a is changed from 0V to the positive voltage value. In this case, the output light of the optical waveguide 100 inputted from the optical waveguide 144 to the optical waveguide 120 is outputted through the optical waveguide 148 when the voltage value of the electrode 130b is a positive voltage value as well as the electrode 110a, and only leakage of light is outputted to the optical waveguide 152 when the voltage is 0V. At this time, the electric field in substantially the same magnitude and the reverse direction with respect to the electric field of the optical waveguide 100 is applied to the optical waveguide 120, and the electric field in substantially the same magnitude and the reverse direction with respect to the electric field of the optical waveguide 105 is applied to the optical waveguide 125. Therefore, the optical coupler 135 generates a chirp of the output light in substantially the same magnitude and the reverse direction with respect to the chirp in the optical coupler 115, so that the chirp generated in the optical coupler 115 can be canceled.

Here, in order to accurately cancel the chirp generated in the optical coupler 115, it is preferred that the optical coupler 115 and the optical coupler 135 are monolithically integrated by the same process and have the same characteristic.

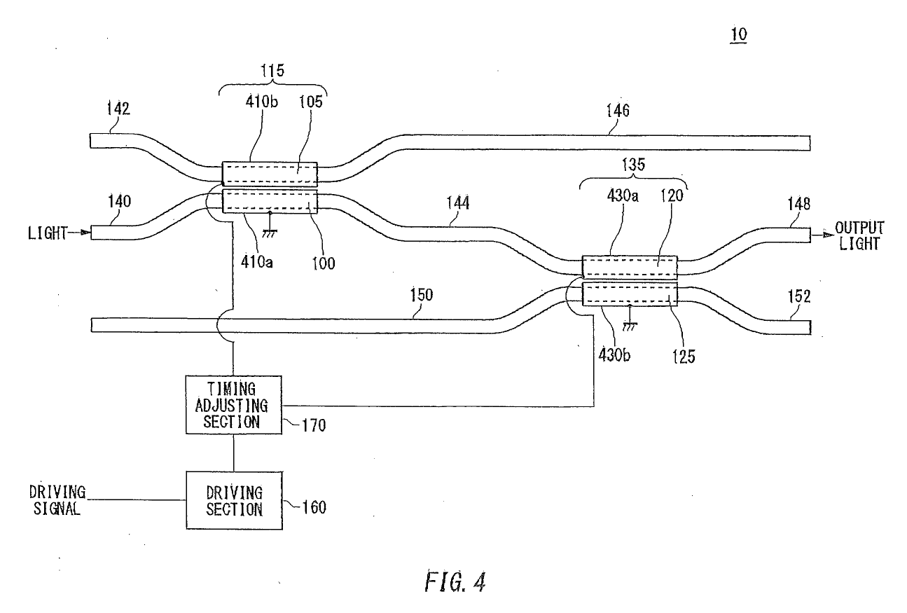

FIG. 4 shows a configuration of the optical switch 10 according to a first modification of the present embodiment. The optical switch 10 according to the present modification switches light by using the optical coupler 135 near the optical output port and cancels the phase modulation by the optical coupler 135 by using the optical coupler 115 near the optical output port. The components in FIG. 4 having reference numerals the same as those of FIG. 1 have the functions and the configurations substantially the same as those of FIG. 1, so that the description will be omitted except for the difference.

The optical coupler 135 is a distributed-coupling type optical coupler including a first optical waveguide 120 and a second optical waveguide 125 arranged in parallel with each other. The optical coupler 135 functions as an optical switch that outputs an input light inputted to the input end of the first optical waveguide 120 from an output end of either the first optical waveguide 120 or the second optical waveguide 125 as an output light.

Electrodes 430 (430a and 430b) apply the electric field corresponding to the first input voltage inputted from the driving section 160 through the timing adjusting section 170 to the first optical waveguide 120 and the second optical waveguide 125 as well as the electrode 110a and the electrode 110b. Thereby it is controlled whether the input light inputted to the optical coupler 135 is outputted from the output end of the optical waveguide 120 as the output light of the optical coupler 135 in accordance with the first input voltage. The electrodes 430 according to the present modification include an electrode 430a which is provided on the top surface of the optical waveguide 120 and to which a positive input voltage is applied, and an electrode 430b which is provided on the top surface of the optical waveguide 125 and grounded.

The optical coupler 115 is a distributed-coupling optical coupler including a third optical waveguide 100 and a fourth optical waveguide 105 arranged in parallel with each other. The third optical waveguide 100 receives light from the outside through the optical waveguide 140 and guides the light to the optical coupler 135 through, the optical waveguide 144 to input the light to the first optical waveguide 120 as an input light to be inputted to the optical coupler 135.

The electrodes 410 (410a and 410b) applies the electric field in the direction opposite to that of the electric field applied from the electrodes 430 to the first optical waveguide 120 and the second optical waveguide 125 to the third optical waveguide 100 and the fourth optical waveguide 105 in accordance with the first input voltage inputted from the driving section 160 through, the timing adjusting section 170. Thereby the electrodes 410 change the phase of the input light propagating through the third optical waveguide 100 substantially by the same amount and in the reverse direction with respect to changing the phase in the optical coupler 135. The electrodes 130 according to the present modification includes an electrode 410a which is provided on the top surface of the optical waveguide 100 and grounded, and an electrode 410b which is provided on the optical waveguide 105 and to which a positive input voltage is applied. Each of the optical coupler 115 and the electrode 410 according to the present modification is an example of the phase modulation reducing section according to the present invention.

The timing adjusting section 170 adjust as well as the timing adjusting section 170 shown in FIG. 1 such that a time period for which a first input voltage is applied to the electrodes 430 after the first input voltage is applied to the electrodes 410 is substantially equal to a time period for which light is inputted to the optical coupler 135 after the inputted light is inputted to the third optical waveguide 100.

In the optical switch 10 according to the present modification, the phase modulation substantially by the same amount and the reverse direction with respect to the phase modulation generated by a switching of the optical coupler 135 is previously added to a laser beam inputted from the outside in the optical coupler 115, so that a chirp generated in the optical coupler 135 can be cancelled.

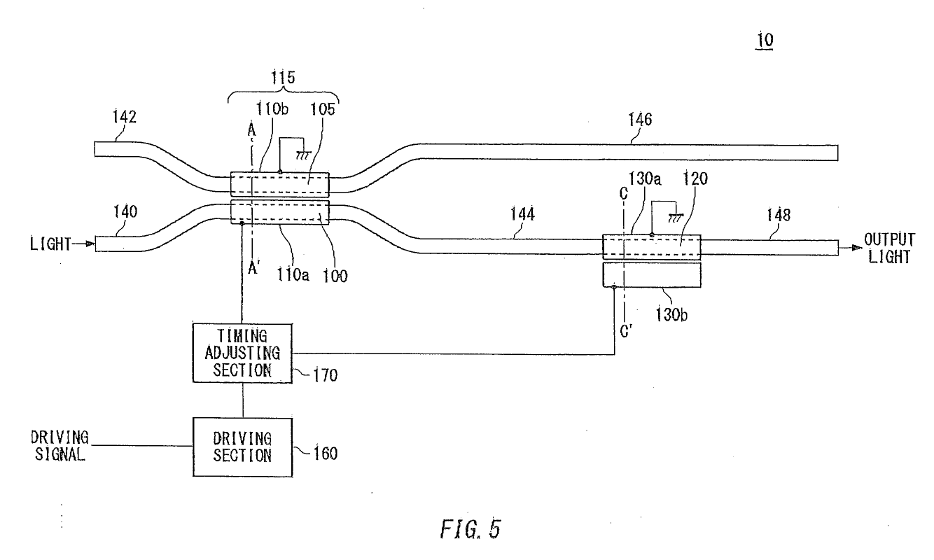

FIG. 5 shows a configuration of the optical switch 10 according to a second modification of the present embodiment. The optical switch 10 according to the present modification switches by the optical coupler 115 whether the input light is outputted from the optical switch 10. Then, the optical switch 10 reduces the phase modification of the output light generated by the optical coupler 115 by means of the optical waveguide 120 and the electrodes 130 and outputs the same to prevent from generating a chirp. The components in FIG. 5 having reference numerals the same as those of FIG. 1 have the functions and the configurations substantially the same as those of FIG. 1, so that the description will be omitted except for the difference.

The optical switch 10 according to the present modification includes an optical coupler 115, electrodes 110 (110a and 110b), a third optical waveguide 120, electrodes 130 (130a and 130b), a plurality of optical waveguides (140, 142, 144, 146 and 148), a driving section 160 and a timing adjusting section 170.

The optical waveguide 120 receives an output light of the optical waveguide 115 outputted from the first optical waveguide 100 and outputs the same through the optical waveguide 148. The electrodes 130 apply to the third optical waveguide 120 the electric field in the direction opposite to that of the electric field applied from the electrodes 110 to the first optical waveguide 100 in accordance with the first input voltage inputted from the driving section 160 through the timing adjusting section 170. Thereby the electrodes 130 change the phase of the output light which propagates through the third optical waveguide 120 substantially by the same amount and the reverse direction with respect to changing the phase in the optical coupler 115. The electrodes 130 according to the present modification include the electrode 130a which is provided on the top surface of the optical waveguide 120 and grounded, and the electrode 130b which is arranged in the vicinity of and in parallel with the electrode 130a on the substrate on which the optical switch 10 is formed and to which a positive input voltage is applied. Each of the optical waveguide 120 and the electrodes 130 in the present embodiment is an example of the phase modulation reducing section according to the present invention.

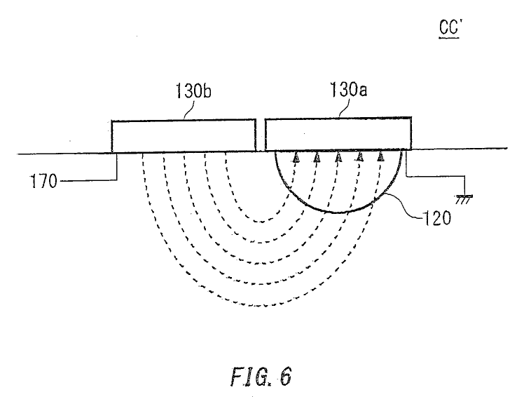

FIG. 6 is a cross-sectional view of the optical switch 10 by CC′ line according to the second modification of the present embodiment. The optical switch 10 according to the present modification is provided on a substrate cut out such that the 2-axis direction of LiNbO₃ crystal is vertical to the substrate. The optical waveguide 120 is provided by dispersing metal such as titanium over the substrate. The electrode 130a is provided on the top surface of the optical waveguide 120 on the substrate and grounded to 0V. The electrode 130b is provided in parallel with and in the vicinity of the electrode 130a on the substrate and receives the input voltage from the timing adjusting section 170.

When a positive input voltage is applied to the electrode 130b, the electric field extending from the electrode 130b to the electrode 130a is generated. Thereby the electric field extending from the under surface direction to the top surface direction of tine substrate is applied to the optical waveguide 120. Meanwhile, the electric filed extending from the top surface direction to the under surface direction of the substrate is applied to the optical waveguide 100 as shown in FIG. 2A.

Thus, the electric field in the same magnitude and the reverse direction with respect to the electric field of the optical waveguide 100 is applied to the optical waveguide 120. Therefore, the optical waveguide 120 generates a chirp of the output light in the same magnitude and the reverse direction with respect to the chirp in the optical coupler 115. Therefore, the phase modulation reducing section having the optical waveguide 120 and the electrodes 130 can cancel the chirp generated in the optical coupler 115.

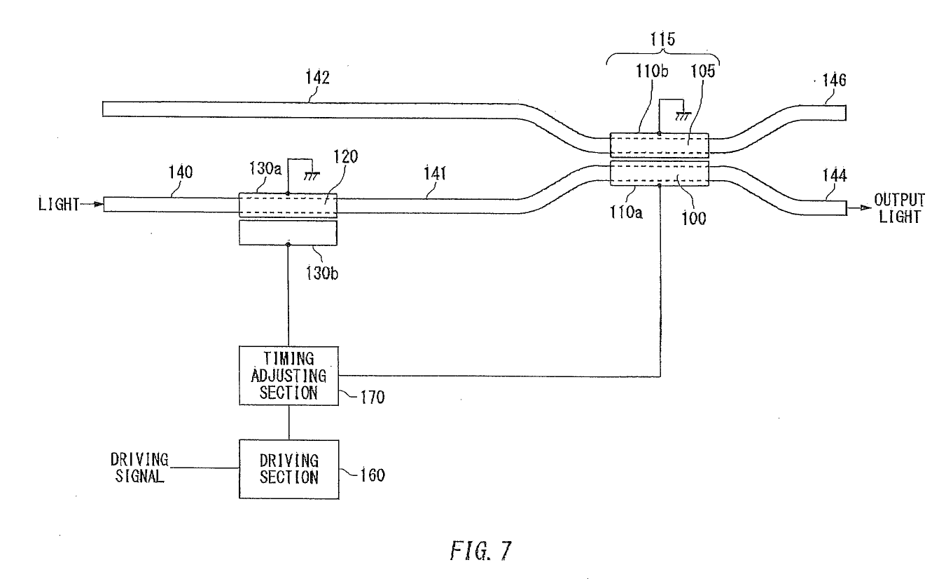

FIG. 7 shows a configuration of the optical switch 10 according to a third modification of the present embodiment. The optical switch 10 according to the present modification includes a phase modulation reducing section having the optical waveguide 120 and the electrodes 130 which are disposed nearer the input port than the optical coupler 115. The components in FIG. 7 having reference numerals the same as those of FIG. 5 have the functions and the configurations substantially the same as those of FIG. 5, so that the description will be omitted except for the difference.

The optical switch 10 according to the present modification includes an optical coupler 115, electrodes 110 (110a and 110b), a third optical waveguide 120, electrodes 130 (130a and 130b), a plurality of optical waveguides (140, 141, 142, 144 and 146), a driving section 160 and a timing adjusting section 170.

The optical waveguide 120 receives light from outside through the optical waveguides 140, and the inputted light is outputted to the optical waveguide 141, so that the light is inputted to the first optical waveguide 100 as an input light. The electrodes 130 apply to the third optical waveguide 120 the electric field in the direction opposite to that of the electric field applied from the electrodes 110 to the first optical waveguide 100 in accordance with the first input voltage inputted from the driving section 160 through the tiring adjusting section 170. Thereby the electrodes 130 change the phase of the input light which propagates through the third optical waveguide substantially by the same amount and the reverse direction with respect to changing the phase in the optical coupler 115. Each of the optical waveguide 120 and the electrodes 130 in the present modification is an example of the phase modulation reducing section according to the present invention.

The timing adjusting section 170 has the functions and the configurations the same as those of the timing adjusting section 170 shown in FIG. 4.

In the optical switch 10 according to the present modification, the phase modulation substantially by the same amount and the reverse direction with respect to the phase modulation generated by a switching in the optical coupler 135 is previously added to a laser beam inputted from the outside in the optical coupler 115, so that a chirp generated in the optical coupler 135 can be cancelled.

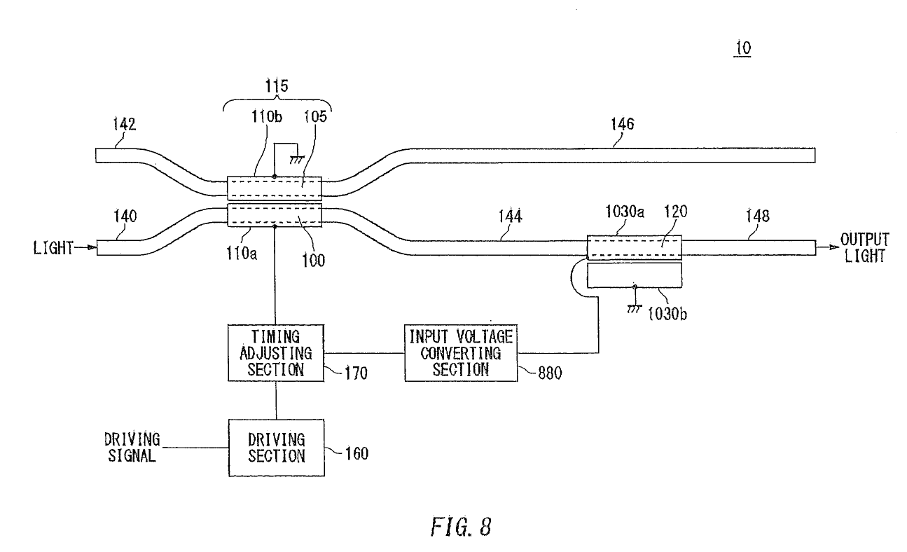

FIG. 8 shows a configuration of the optical switch 10 according to a fourth modification of the present embodiment. The optical switch 10 according to the present modification switches light by using a normally off type optical coupler 115 disposed near the input port and cancels the phase modulation by the optical coupler 115 by using a normally-on type optical coupler 135 disposed near the output port. Then, an input voltage converting section 880 generates an input voltage applied to the optical coupler 135 such that the optical coupler 135 and the optical coupler 115 are turned on/off at the same time. The components in FIG. 8 having reference numerals the same as those of FIG. 5 have the functions and the configurations substantially the same as those of FIG. 5, so that the description will be omitted except for the difference.

The input voltage converting section 880 generates the second input voltage applied to the optical coupler 115 by subtracting the first input voltage applied to the optical coupler 135 from a predetermined reference voltage.

The electrodes 1030 (1030a and 1030b) apply the electric field in the direction the same as that applied from the electrodes 110 to the fourth optical waveguide 100 to the optical waveguide 120 in accordance with the second input voltage inputted from the input voltage converting section 880. Here, the second input voltage is obtained by subtracting the first input voltage from the reference voltage V₁, for example. Therefore, the electrodes 1030 change the phase of the output light which propagates through the third optical waveguide 100 and the fourth optical waveguide 105 substantially by the same amount and in the reverse direction with respect to changing the phase in the optical coupler 115. The electrodes 1030 according to the present embodiment include the electrode 1030a which is provided on the top surface of the third optical waveguide 120 and grounded, and the electrode 1030b which is arranged in the vicinity of and in parallel with the electrode 1030a on the substrate on which the optical switch 10 is formed and to which a positive input voltage is applied. Each of the optical waveguide 120 and the electrodes 1030 in the present modification is an example of the phase modulation reducing section according to the present embodiment.

The optical switch 10 according to the present modification can change the electric field of the optical waveguide 120 in a direction opposite to the change of the electric filed applied to the optical waveguide 100. Thereby the phase modulation reducing section having the optical waveguide 120 and the electrodes 1030 generates a chirp of the output light in the same magnitude and the reverse direction with respect to the chirp in the optical coupler 115. As the result of this, the phase modulation reducing section having the optical waveguide 120 and the electrodes 1030 can cancel the chirp generated in the optical coupler 115.

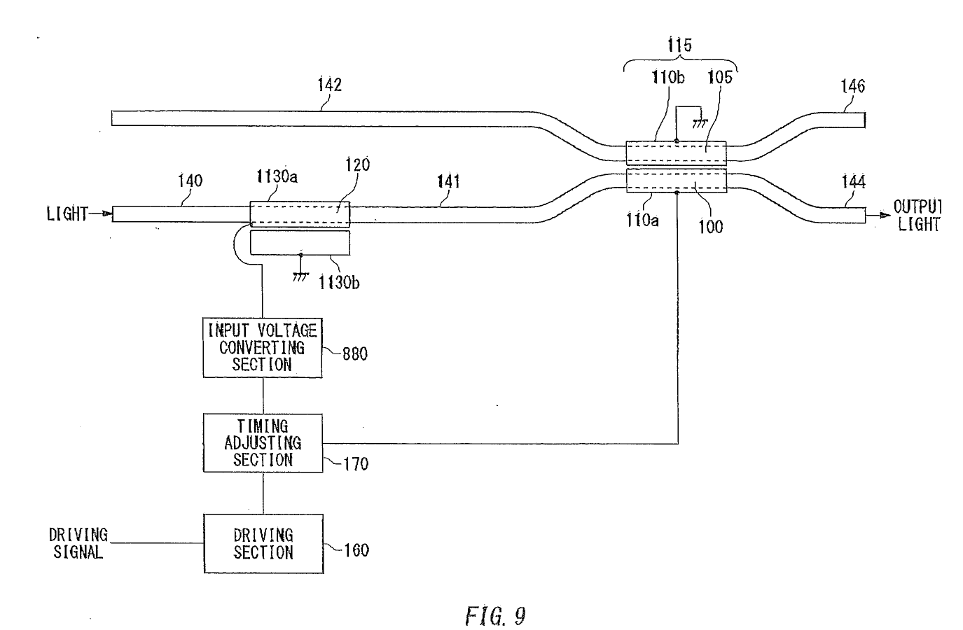

FIG. 9 shows a configuration of the optical switch 10 according to a fifth modification of the present embodiment. The optical switch 10 according to the present modification includes a phase modulation reducing section having the optical waveguide 120 and electrodes 1130 which are disposed nearer the optical input port than the optical coupler 115. The components in FIG. 9 having reference numerals the same as those of FIG. 7 have the functions and the configurations substantially the same as those of FIG. 7, so that the description will be omitted except for the difference.

The optical switch 10 according to the present modification includes an optical coupler 115, electrodes 110 (110a and 110b), a third optical waveguide 120, electrodes 1130 (1130a and 1130b), a plurality of optical waveguides (140, 141, 142, 144 and 146), a driving section 160, a timing adjusting section 170 and an input voltage converting section 880.

The input voltage converting section 880 generates the second input voltage applied to the electrodes 1130 by subtracting the first input voltage applied to the optical coupler 115 from a predetermined reference voltage.

The electrodes 1130 apply to the third optical waveguide 120 the electric field in the direction the same as that of the electric field applied from the electrodes 110 to the first optical waveguide 100 in accordance with the second input voltage. Here, the second input voltage has the voltage value obtained by subtracting the first input voltage from the reference voltage V₁, for example, so that the electrodes 1130 change the phase of the input light which propagates through the third optical waveguide 120 substantially by the same amount and in the reverse direction with respect to changing the phase in the optical coupler 115. The electrodes 1130 according to the present modification include the electrode 1130a which is provided on the top surface of the third optical waveguide 120 and to which a positive input voltage is applied, and the electrode 1130b which is provided in the vicinity of and in parallel with the electrode 1130a on the substrate on which the optical switch 10 is formed, and grounded. Each of the optical waveguide 120 and the electrodes 1130 is an example of the phase modulation reducing section according to the present invention.

The optical switch 10 according to the present modification can change the electric field of the optical waveguide 120 in a direction opposite to the change of the electric field applied to the optical waveguide 100. Thereby the phase modulation reducing section having the optical waveguide 120 and the electrodes 1130 can previously add a chirp to a laser beam inputted from the outside substantially by the same magnitude and in the reverse direction with respect to the chirp generated by switching in the optical coupler 115.

As the result of this, the phase modulation reducing section having the optical waveguide 120 and the electrodes 1130 can cancel the chirp generated in the optical coupler 115.

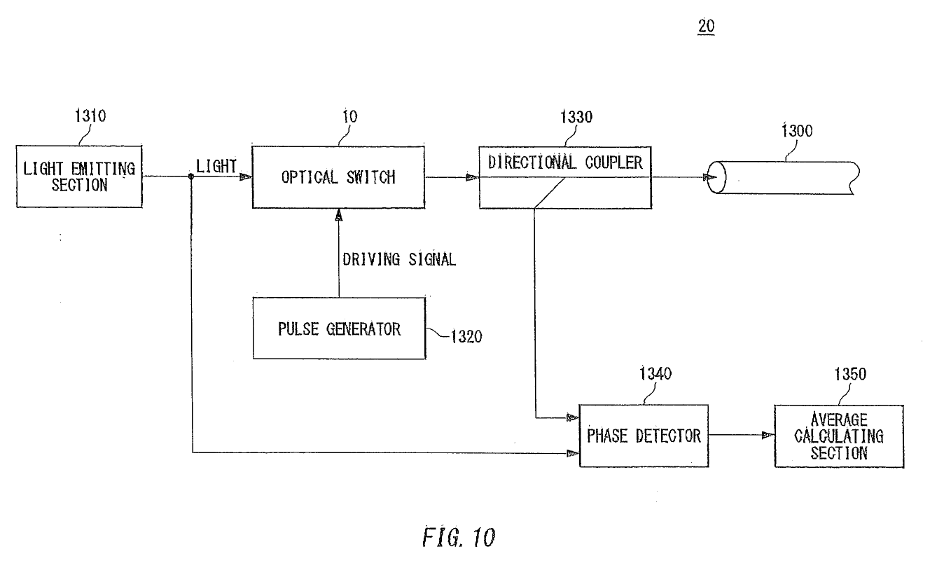

FIG. 10 shows a configuration of an optical test apparatus 20 according to the present embodiment. The optical test apparatus 20 inputs an optical pulse signal generates by the optical switch 10 according to the present embodiment to an optical fiber 1300—under test and tests the optical fiber 1300 based on such as a reflected tight from the optical fiber 1300. Thereby the optical test apparatus 20 can accurately test the optical fiber 1300 by using the optical pulse signal with reduced frequency chirp. Particularly, B-OTDR (Brillouin Optical Time Domain Reflectmetry) that measures the amount of distortion of a fiber based on the frequency shift of stimulated Brillouin scattering in the fiber detects the frequency of Brillouin scattering by means of the heterodyne detection method. Therefore, when an optical pulse as a probe includes any frequency chirp, the accuracy of the measurement is reduced.

The optical test apparatus 20 includes a light emitting section 1310, a pulse generator 1320, an optical switch 10, a directional coupler 1330, a phase detector 1340 and an average calculating section 1350. The light emitting section 1310 is a laser diode, for example, which generates a coherent laser beam. The pulse generator 1320 generates a pulse signal having a predetermined pulse width.

The optical switch 10 inputs light generated by the light emitting section 1310 from an optical input port and inputs a pulse signal generated by the pulse generator 1320 as a driving signal. Thereby the optical switch 10 switches whether the light generated by the light emitting section 1310 is outputted based on the pulse signal. More specifically, the optical switch 10 blocks the light generated by the light emitting section 1310 and does not output the same from an optical output port while the logical value of the pulse signal indicates L. Meanwhile, the optical switch 10 passes therethrough the light generated by the light emitting section 1310 and outputs the same from the optical output port.

The directional coupler 1330 inputs the light outputted from the optical switch to the optical fiber 1300 which is an example of external optical waveguide. In addition, the directional coupler 1330 acquires a back-scattered light and a reflected light from the optical fiber 1300 and provides the same to the phase detector 1340. The phase detector 1340 detects the back-scattered light and the reflected light acquired from the optical fiber 1300. The phase detector 1340 according to the present embodiment heterodyne-detects the back-scattered light and the reflected light acquired from the optical fiber 1300 based on the light generated by the light emitting section 1310. The average calculating section 1350 averages output signals from the phase detector 1340 and displays the same to the operating personnel.

As described above, the optical test apparatus 20 can test the optical fiber 1300 with a laser pulse beam having a reduced frequency chirp by using the optical switch 10. Thereby the frequency variation generated in the received signal during heterodyne-detecting can be reduced.

While the present invention has been described with the embodiment, the technical scope of the invention not limited to the above described embodiment. It is apparent to persons skilled in the art that various alternations and improvements can be added to the above-described embodiment. It is apparent from the scope of the claims that the embodiment added such alternation or improvements can be included in the technical scope of the invention.

For example, the optical switch 10 may be provided on the substrate (z-plate) vertical to the z-axis direction of LiNbO₃ crystal instead of being provided on the substrate (x-substrate) vertical to the x-axis direction of LiNbO₃ crystal. In this case, each of the electrodes 110, the electrodes 130, the electrodes 410, the electrodes 430, the electrodes 830, the electrodes 910, the electrodes 1030 and the electrodes 1130 applies the electric field in the horizontal direction of the substrate vertical to the extending direction of the electrode.

Moreover, the optical coupler 115 or the optical coupler 135 that performs switching may be a reversed coupling type optical switch having the length twice as long as the perfect coupling length, where the pole of the electrode on the perfect coupling length part near the optical input side may be reversed to the pole of the electrode on the perfect coupling length part near the optical output side. In this case, the phase modulation reducing section may have the stricture adapted to the reversed coupling type optical switch that has the length twice as long as the perfect coupling length, where the pole of the electrode on the perfect coupling length part near the optical input side is reversed to the pole of the electrode on the perfect coupling length part near the optical output side, and apply the electric field to the optical waveguide.

Moreover, in the optical switch 10, the optical waveguide in the phase modulation reducing section may be domain-reversed (polarization-reversed) to the optical coupler 115 or the optical coupler 135 which performs switching. In this case, in order to apply the electric field in a direction opposite to the polarization of the optical coupler 115 or the optical coupler 135, the electrodes in the phase modulation reducing section applies the electronic field by the same amount and in the same direction physically. Thereby the phase modulation reducing section can achieve the same effect as that the electric field is applied by the same amount and in the reverse direction to the optical waveguide of which polarization is not reversed.

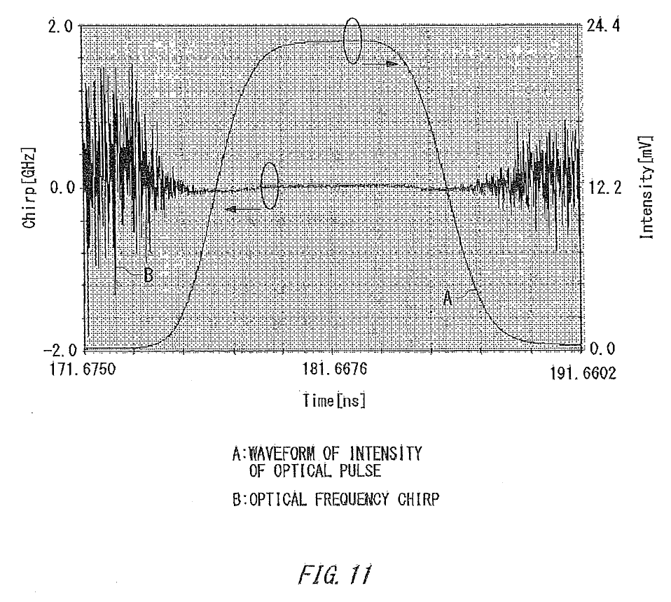

As described above, according to the present invention, an optical switch and optical test apparatus being capable of preventing from generating a chirp due to switching. FIG. 11 shows actual measuring data of an optical pulse shape generated by the optical switch and the frequency chirp thereof. It shows that the chirp is completely eliminated even at the riding and the falling of the optical pulse.

What is claimed is:

1. An optical switch comprising
a first distributed-coupling type optical coupler having a first optical waveguide and a second optical waveguide arranged in parallel with each other that outputs an input light inputted to an input end of the first optical waveguide from an output end of either the first optical waveguide or the second optical waveguide as output light;
a first electrode that applies an electric field corresponding to the first input voltage to the first optical waveguide and the second optical waveguide and controls whether the input light inputted to the first optical coupler is outputted as the output light based on the first input voltage; and
a phase modulation reducing section that reduces the phase change of the output light in accordance with the change of the electric field applied to the first optical waveguide and the second optical waveguide.

2. The optical switch as set forth in claim 1, wherein the phase modulation reducing section changes the phase of the output light substantially by the same amount and in the reverse direction with respect to changing the phase of the output light in accordance with the change of the electric field applied to the first optical waveguide and the second optical waveguide.

3. The optical switch as set forth in claim 2, wherein the phase modulation reducing section including:
a distributed-coupling type second optical coupler having a third optical waveguide to which the output light outputted from the output end of the first optical waveguide is inputted and a fourth optical waveguide arranged in parallel with the third optical waveguide that outputs the output light of which phase modulation by the first optical coupler is reduced from the third optical waveguide; and
a second electrode that applies to the third optical waveguide and the fourth optical waveguide an electric field in the direction opposite to that of the electric field applied from the first electrode to the first optical waveguide and the second optical waveguide in accordance with the first input voltage, and changes the phase of the output light propagating through the third optical waveguide substantially by the same amount and in the reverse direction with respect to changing the phase in the first optical coupler.

4. The optical switch as set forth in claim 2, wherein the phase modulation reducing section including:
a third optical waveguide that receives the output light; and
a second electrode that applies to the third optical waveguide the electric field in the direction opposite to that of the electric field applied from the first electrode to the first optical waveguide in accordance with the first input voltage, and changes the phase of the output light propagating through the third optical waveguide substantially by the same amount and the reverse direction with respect to changing the phase in the first optical coupler.

5. The optical switch as set forth in claim 3 further comprising a timing adjusting section that adjusts such that a time period for which the first input voltage is applied to the second electrode after the first input voltage is applied to the first electrode is substantially equal to a time period for which the output light is inputted to the third optical coupler after the input light is inputted to the first optical coupler.

6. The optical switch as set forth in claim 2, wherein
the phase modulation reducing section including:
a distributed-coupling type second optical coupler having a third optical waveguide to which light is inputted from the outside, the input light is inputted to the first optical waveguide and a fourth optical waveguide arranged in parallel with the third optical waveguide; and
a second electrode that applies to the third optical waveguide and the fourth optical waveguide an electric field in the direction opposite to the electric field applied from the first electrode to the first optical waveguide and the second optical waveguide in accordance with the first input voltage, and changes the phase of the input tight propagating the third optical waveguide substantially by the same amount and in the reverse direction with respect to changing the phase in the first optical coupler.

7. The optical switch as set forth in claim 2, wherein
the phase modulation reducing section including:
a third optical waveguide to which light is inputted from the outside, the input light is inputted to the first optical waveguide; and
a second electrode that applies to the third optical waveguide an electric field in the direction opposite to the electric field applied from the first electrode to the first optical waveguide in accordance with the first input voltage, and changes the phase of the input light propagating the third optical waveguide substantially by the same amount and in the reverse direction with respect to changing the phase in the first optical coupler.

8. The optical switch as set forth in claim 6 further comprising a timing adjusting section that adjusts such that a time period for which the first input voltage is inputted to the first electrode after the first input voltage is the second electrode is substantially equal to a time period for which light is inputted to the first optical waveguide after the input light is inputted to the third optical coupler.

9. The optical switch as set forth in claim 2, wherein the phase modulation reducing section including:
a distributed-coupling second optical coupler having a third optical waveguide to which the output light outputted from the output end of the first optical waveguide is inputted and a fourth optical waveguide arranged in parallel with the third optical waveguide that outputs the output light of which phase change by the first optical coupler is reduced from the fourth optical waveguide;
an input voltage converting section that generates the second input voltage by subtracting the first input voltage from a predetermined reference voltage; and
a second electrode that applies to the third optical waveguide and the fourth optical waveguide an electric field in the direction the same as that of the electric field applied from the first electrode to the first optical waveguide and the second optical waveguide in accordance with the second input voltage, and changes the phase of the output light propagating the third optical waveguide and the fourth optical waveguide substantially by the same amount and in the reverse direction with respect to changing the phase in the first optical coupler.

10. The optical switch as set forth in claim 9 further comprising a timing adjusting section that adjusts such that a time period for which the second input voltage is applied to the second electrode after the first input voltage is applied to the first electrode is substantially equal to a time period for which the output light is inputted to the third optical waveguide after the input light is inputted to the first optical waveguide.

11. The optical switch as set forth in claim 2, wherein the phase modulation reducing section including:
a distributed-coupling type second optical coupler having a third optical waveguide to which light is inputted from the outside and a fourth optical waveguide arranged in parallel with the third optical waveguide, wherein the input light inputted to the third optical waveguide is inputted to the first optical waveguide;
an input voltage converting section that generates the second input voltage by subtracting the first input voltage from a predetermined reference value; and
a second electrode that applies to the third optical waveguide and the fourth optical waveguide an electric field in the direction the same as that of the electric field applied from the first electrode to the first optical waveguide and the second optical waveguide in accordance with the second input voltage, and changes the phase of the input light propagating through the third optical waveguide substantially by the same amount and in the reverse direction with respect to changing the phase in the first optical coupler.

12. The optical switch as set forth in claim 11 further comprising a timing adjusting section that adjusts such that a time period for which the first input voltage is applied to the first electrode after the second input voltage is applied to the second electrode is substantially equal to a time period for which light is inputted to the first optical coupler after the input light is inputted to the third optical waveguide.

13. The optical switch as set forth in claim 4 further comprising a timing adjusting section that adjusts such that a time period for which the first input voltage is applied to the second electrode after the first input voltage is applied to the first electrode is substantially equal to a time period for which the output light is inputted to the third optical waveguide after the input light is inputted to the first optical coupler.

14. The optical switch as set forth in claim 7 further comprising a timing adjusting section that adjusts such that a time period for which the first input voltage is applied to the first electrode after the first input voltage is applied to the second electrode is substantially equal to a time period for which light is inputted to the first optical coupler after the input light is inputted to the third optical waveguide.

15. An optical test apparatus comprising
a light emitting section that emits light;
a pulse generator that generates a pulse signal;
an optical switch that switches whether the light emitted from the light emitting section is outputted based on the pulse signal;
a directional coupler that inputs the light outputted from the optical switch to an external optical waveguide and acquires a reflected light from the external optical waveguide; and
a phase detecting section that detects the phase of the reflected light acquired from the external optical waveguide,
the optical switch including:
a first distributed-coupling type optical coupler having a first optical waveguide and a second optical waveguide arranged in parallel with each other that outputs an input light inputted to an input end of the first optical waveguide from an output end of either the first optical waveguide or the second optical waveguide as output light;
a first electrode that applies an electric field corresponding to the first input voltage to the first optical waveguide and the second optical waveguide and controls whether the input light inputted to the first optical coupler is outputted as the output light based on the first input voltage; and
a phase modulation reducing section that reduces the phase change of the output light in accordance with the change of the electric field applied to the first optical waveguide and the second optical waveguide.

16. The optical test apparatus as set forth in claim 15, wherein the directional coupler acquires light including any one of a scattered light or a reflected light from the external optical waveguide.
